(19) United States
(12) Patent Application Publication
(10) Pub. No.: US 2004/0224853 A1
(43) Pub. Date: Nov. 11, 2004

(54) Drilling fluid additives

(76) Inventor: Ricardo Jasinski, San Isidro (AR)

Correspondence Address: ZARLEY LAW FIRM P.L.C., CAPITAL SQUARE, 400 LOCUST, SUITE 200, DES MOINES, IA, 50309-2350, US

(21) Appl. No.: 10/837,845

(22) Filed: May 3, 2004

(30) Foreign Application Priority Data
May 2, 2003 (AR) P030101541

(51) Int. Cl. C09K 7/02

(52) U.S. Cl. 507/140

(57) ABSTRACT

A class of additives, that improve the viscosity and rheological properties of drilling fluids, are mixtures of materials comprising modified tannins, modified lignites, modified lignosulfonates and metal compounds including iron, tin, chrome, manganese, titanium, aluminum, or zinc. In one aspect, the invention is directed to improving the dispersion properties of those materials known as sulfoalkylated tannins, oxidized by a strong oxidation process in an alkali environment with oxygen, ozone, or an oxidizing agent including hydrogen peroxide, sodium perborate, sodium peroxycarbonate or mixtures thereof. In a further aspect the invention refers to an additive composition to improve the properties of drilling fluid, completion, and work-over fluids. The amount of additive to be added to the drilling, completion, or work-over fluid should be enough to reduce at least one of the parameters including: plastic viscosity; yield point; 10 second and 10 minute gels; or water-loss caused by filtering.

### FIELD OF THE INVENTION

The present invention relates to the drilling and servicing of wells drilled in fluid producing formations or oil reservoirs, and more particularly to additive compositions that improve the properties of the drilling, completion and work-over fluids.

### BACKGROUND OF THE INVENTION

In the art of drilling wells to tap subterranean deposits of fluids such as oil and/or gas, especially when drilling by the rotary method employing a rotary bit and drill stem, a drilling fluid, usually a compounded fluid made to predetermined physical and chemical properties, is circulated to the bottom of the bore hole, out through openings in the bit at the bottom of the bore hole, and then back up said bore hole to the surface by passage through the annular space between said drill stem and the wall of said bore hole (or between said drill stem and the wall of the casing where casing has been put in place). The bit is turned by rotating the entire string from the surface or by using a downhole motor. Circulation of the drilling fluid in this manner removes the cuttings from the bore hole, lubricates and cools the drill bit, seals the wall of the bore hole with a thin impervious layer and applies a hydrostatic head to the formation to counterbalance formation pressures. After reaching the surface, the drilling fluid is passed through a series of screens, settling tanks or other equipment to remove formation material brought to the surface. It is then treated with additives to obtain a desired set of properties. Once treated the fluid is pumped back into the well and the cycle repeated.

Most drilling, completion and workover fluids are complex mixtures of interacting chemical compounds and their properties change remarkably with changes in temperature, shear rate and shear history. As drilling fluids circulate through the bore hole they are subjected to ever changing conditions such as turbulent flow in the drill pipe, intense shearing at the bit, and nominal laminar flow in the annulus.

Accordingly one of the most desirable characteristics of drilling fluids as a class of material is versatility which can be achieved by foresighted treatment with carefully selective additives. A variety of drilling fluid additives are known. The commonly used additives include clays, viscosifiers, fluid loss control agents, thinners, lubricants, biocides, surface active agents, weighting materials, flocculants, shale inhibitors, defoamers, caustic, salts, etc. In drilling certain earth formations such as gypsum or other soluble organic salts, or formations containing swelling clays, or also in deep hot wells, a gelatin and/or thickening of the drilling fluid frequently occurs, such that the viscosity of the drilling fluid becomes excessive and there is danger of loosing control of mud properties, of high pump pressure, of slowing the drilling rate, of not passing through screen of shale shaker, of loosing mud circulation, of gas cutting in the mud, or of blowout occurring. For control of rheological flow properties of the drilling fluid, which is the primary concern of this invention, knowledge of the plastic viscosity (PV), yield point (YP), and the gel strengths (Gel) is necessary. The PV/YP ratio characterizes the shear thinning properties of the drilling fluid i.e. the degree to which the effective viscosity declines with increase in rate of shear. Excessively high yield points or gel strengths are reduced by the addition of certain compounds known as thinners. When added to the drilling fluid these thinners reduce flow resistance and gel development. Materials commonly used as thinners for clay-water drilling fluids can be broadly classified as (1) plant tannins, (2) polyphosphates, (3) lignite materials, (4) lignosulfonates, and (5) synthetic polymers.

Numerous drilling fluid additive mixtures comprising various combinations of materials such as lignosulfonates, modified lignosulfonates, lignite, modified lignite, tannins and modified tannins with selected metal compounds [lave been patented. Reference is had to U.S. Pat. Nos. 4,704,214, 4,842,770 and 4,618,433 the disclosures of which are incorporated herein by reference.

While the additive mixtures disclosed in the above mentioned patents have been successfully employed in well drilling operations there is a continuing need to provide a more cost effective additive which is environmentally acceptable.

Accordingly, it is an object of this invention to provide new drilling fluid additives having improved thinning properties.

One aspect of this invention relates to additives that improve the viscosity and thinning properties of drilling, completion and work-over fluids.

Another object of this invention relates to a mixture of additives having different thinning properties, which mixture provides improved thinning effects compared to those of the components from which the mixture is formulated.

A further object of the invention relates to the improvement of the thinning properties of the known materials achieved by an oxidation process that provides additives with better yields than the starting material.

A more specific object of this invention is to provide an improved drilling fluid having enhanced viscosity or other rheological characteristics.

Another object of this invention is to provide a method of using the improved drilling fluid in the drilling, completion, or workover of wells.

Still another objective of this invention is to provide a method of producing drilling fluid additive blends which are characterized by increased simplicity and efficiency.

Other aspects, objects and advantages of the invention will be apparent to those skilled in the art in view of this disclosure.

### SUMMARY OF THE INVENTION

According to this invention, this novel class of additives, when added to water-based drilling fluids, improves the viscosity and rheological properties thereof. The novel additives are mixtures of materials comprising modified tannins, modified lignites, modified lignosulfonates and metallic compounds selected from the group consisting of iron, tin, chrome, manganese, titanium, aluminum and zinc.

In one respect, the invention provides the improvement of the thinning properties of materials known as sulfoalkylated tannins, oxidized by a strong oxidation process in an alkali environment with oxygen, air, ozone or any oxidizing agent selected from the group consisting of hydrogen peroxide, sodium perborate, sodium peroxy-carbonate and mixtures thereof.

In a further aspect, the invention relates to an additive composition to improve the properties of drilling fluids, completion and work-over fluids, which additive comprises sulfoalkylated tannin modified by strong oxidation, combined with a metal compound comprising at least one metal selected from: iron, tin, chrome, manganese, titanium, aluminum, and zinc, optionally with causticized lignite and/or a lignosulfonate salt as well, which may or not be partially or totally oxidized.

In still another aspect of the invention, there is provided an additive composition to improve the properties of drilling fluid, completion and work-over fluids, which additive comprises sulfoalkylated tannin modified by strong oxidation, combined with a metal compound comprising at least one metal selected from: iron, tin, chrome, manganese, titanium, aluminum, and zinc, together with a lignosulfonate salt, which may or not be partially or totally oxidized, and/or an oxidized causticized lignite.

The amount of additive to be added to the drilling, completion or work-over fluid will be sufficient to lower at least one of the parameters including: A) viscosity, B) yield point, or C) 10 second gels and 10 minute gels, D) water loss.

### DETAILED DESCRIPTION OF THE INVENTION

The drilling, completion and work-over fluids to which this invention applies are those conventionally known as water-based fluids. Generally, fluids contain clay, such as bentonites, kaolinites or yllites, as well as thickeners, all of which is suspended in water. The typical fluids to which this invention can be applied are the ones mentioned in the examples in U.S. Pat. No. 3,028,333.

The first component, and eventually the second component in the mixture of additives, is selected from the group comprising modified tannin, a modified lignite, and a modified lignosulfonate. The preferred modified tannin is the tannin from oxidized sulfomethylated quebracho (OSMQ). Any lignite or byproduct thereof can be used according to this invention. The preferred lignite is a kind of lignite that undergoes a process of strong oxidation in an alkali environment, with hydrogen peroxide. The first aspect of the invention provides the improvement of the dispersing properties of those materials known as sulfoalkylated tannins, which undergo a process of strong oxidation in an alkali environment with oxygen, air, ozone or an oxidizing agent selected from the group consisting of hydrogen peroxide, sodium perborate, sodium peroxycarbonate.

Modified Tannin

Sulfoalkylated tannins are known in the art, they are commercially available, and methods for their preparation and use in drilling fluids are disclosed, e.g., in U.S. Pat. No. 4,704,214, herein incorporated by reference.

The tannins that may be used in the preparation of sulfoalkylated tannins according to the present invention are plant tannins including gallotannins and flavotannins (or cathecols). The term “tannin” as used herein and in the claims includes plant tannins: gallotannnins and flavotannins. Flavotannins are preferred, particularly quebracho tannin, which is the preferred material used to prepare the oxidized sulfomethylated quebracho (OSMQ).

Modified Lignite

Modified lignite can be made from high-oxygen lignites with 70% solubility in an alkali environment and containing a great amount of available humic and fulvic acids. The leonardite from SOUTH DAKOTA, USA reservoirs is the preferred lignite used in the practice of this invention and it is commercially available. A solution of lignite alkalized with caustic soda and/or caustic potash is oxidized with oxygen, air, ozone or with an oxidizing agent selected from the group consisting of hydrogen peroxide, sodium perborate, sodium peroxycarbonate and mixtures thereof. Lignite is subjected to strong oxidation until a final pH of less than 10.5 is achieved. Lignites or leonardites contain, after being extracted, milled and dried, long chain, medium chain, and short chain humic acids. However, during the oxidation process, the oxidant attacks and breaks the long chains and partially converts them to medium and short chains.

The oxidized lignite (OL) has greater oxygen content and a higher solubility in an alkali environment. These properties of humic acid improve its effectiveness as a dispersant compared to the causticized lignite commercially used in drilling fluids or in commercial mixtures, together with quebracho tannin and sulfomethylated quebracho. Oxidized lignite has a lower pH and greater solubility than those commercially available at present. The lower alkalinity or pH is an advantage, since it does not increase the fluid pH and, furthermore, it is not necessary to add any more caustic soda to solubilize lignite.

Method of Preparation of the Composition the Preparation of the Additive Comprises Three Steps:

Step 1: Oxidation of the organic compound: Sulfoalkylated tannin, causticized lignite, and sodium lignosulfonate.

Step 2: Spray drying or drum drying or any other industrial method to achieve a water-soluble powder.

Step 3: Mixing the oxidized organic compound(s) with the metal salts in the specified ratios by dual screw, dual cone-type powder mixers ribbon blender, or any other industrial mixing equipment.

Step 1 and Step 2

Oxidation:

Oxidation of organic compounds can be effected individually, i.e. oxidizing the sulfoalkylated tannin, oxidizing the causticized lignite or lignosulfonate or oxidizing the desired mixture, sulfoalkylated tannin plus causticized lignite, or the mixture of sulfoalkylated tannin plus lignosulfonate, or other combinations.

U.S. Pat. No. 5,026,416 AND U.S. Pat. No. 5,034,045 patents also disclose oxidative processes. However, such documents disclose a mild oxidation, in contrast with the present invention, which requires a strong oxidation of the components.

Additive Mixture

The compound of the invention is a mixture of additives. These additives synergistically cooperate within the compound such that the dispersion characteristics or other Theological properties of the drilling fluid containing the same are improved.

Furthermore, in certain instances, the incorporation or replacement of a part of the oxidized sulfomethylated tannin (OSMQ) by oxidized lignosulfonate (OLS) and/or humic acid or oxidized lignite (OL) reduces cost without compromising the performance of the final additive as to its dispersing power. The examples below are given to illustrate the invention. In these examples, mixtures are compared both before and after the oxidation and with or without the third metal component in the combination.

For the sulfomethylated quebracho tannin, it is compared, combined with the metal compound, both before and after its oxidation.

Percentages of the components included in the final mixture of this invention are given in TABLE A.

For commercial use, the components may be mixed in any industrial equipment with a capability to mix dry powder.

TABLE A
AMOUNT OF EACH COMPONENT
IN THE FINAL ADDITIVE

| | General range | Preferred range |
|---|---|---|
| | wt % | wt % |
| FIRST COMPONENT (I) | 40-90 | 50-70 |
| SECOND COMPONENT (II) | 10-50 | 20-10 |
| (optional) | | |
| THIRD COMPONENT (III) | 5-25 | 8-15 |

FIRST COMPONENT: Selected from modified tannin, oxidized sulfomethylated tannin.

SECOND COMPONENT: Oxidized Lignite, oxidized Sodium Lignosulfonate.

THIRD COMPONENT: metal compound of iron, chrome, tin, manganese, titanium, aluminum, zinc or mixtures thereof.

The base drilling fluid (base fluid) is prepared in a conventional manner, by mixing 10,000 ml tap water, 470 g API standard bentonite, and stirring at 10,000 r.p.m. with a multi-mixer. Thereafter, 2,350 g clay (yllite) is added and stirred for 10 minutes, followed by the addition of 5,600 g baritine with stirring for 30 minutes. It is left to age for 24 hours.

The method of preparing the composition of the present invention is mainly composed of the steps of:

a) preparing an aqueous solution of at least one organic compound selected from sulfoalkylated tannin, causticized lignite and lignosulfonate salt,

b) optionally strongly oxidizing such aqueous solution under basic conditions to a final pH of less than 10,

c) drying said optionally strongly oxidized aqueous solution to achieve a powder,

d) mixing the powder with a metal compound comprising at least one metal selected from iron, tin, chrome, manganese, titanium, aluminum, and zinc, and eventually with the non-oxidized components not selected in step a).

Oxidation may be carried out in a solid or liquid phase with H₂O₂, or by bubbling air or oxygen. The solid phase reaction has certain advantages in drying, but some disadvantages when managing the reaction. The oxidation time may range from 1 to 6 hours, whereas the oxidation temperature may range between 70 and 110° C., with 90° C. being the preferred temperature.

The percentage of H₂O₂ (250 vol) in the liquid phase should be at least 0.6 wt %, such that the weight ratio to the organic phase to be oxidized is at least 1.5 wt %. The final pH value of the liquid phase should not exceed 10 and the drying may be effected by spraying or other methods.

The following examples further illustrate the invention.

Examples A, B, and C show the individual oxidations of the organic compounds and mixtures 10, 16, 22, 12, 18, and 24 in the mixing step with metal salts.

### EXAMPLE A

Oxidized Sulfomethylated Quebracho Tannin

A 40% (w/w) aqueous solution of sulfomethylated quebracho tannin (SMQ) is prepared, starting from the commercial product, or else it is synthesized according to the teachings of the aforementioned patents.

Such solution is taken to pH 11.5-12.0 with caustic soda or potash and it is oxidized at 90° C. with stirring for one hour with 5% hydrogen peroxide (250 vol) up to a final pH=10. It is spray dried or dried by other methods. An alternative method is air oxidation. In a 2 liter autoclave, a 40% (w/w) aqueous solution of sulfomethylated quebracho tannin is poured; it is taken to pH 11.0-12.0 and it is oxidized for 3 hours at 90° C. with a bubbling air stream and continuous stirring. In both cases, OSMQ is achieved. The final pH is lower than 10.5.

### EXAMPLE B

Oxidized Lignite (OL)

A 40% w/w aqueous solution of causticized lignite (TAHHATHIN, causticized leonardite from SOUTH DAKOTA (trademark) MI) or non causticized lignite (LIG) from South Dakota is prepared and taken to pH 11.0-12.00 with caustic soda. It is oxidized with 5% hydrogen peroxide (250 vol.) at 90° C. for one to two hours until the final pH=10, with stirring, after which it is spray dried or otherwise dried. An alternative form of oxidation is by bubbling air or oxygen through the solution, achieving a final pH=10.

A 40% w/w non-causticized lignite (LlG) suspension is poured into a 2 liter autoclave. It is alkalized to pH 11.0-12.0 with caustic soda and air is constantly bubbled at 90° C. with stirring for 6 hours until final pH=10. The suspension is spray dried.

In both cases, soluble oxidized lignite with 90-100% humate content is achieved.

### EXAMPLE C

Oxidized Sodium Lignosulfonate (OSL)

A 40% p/p aqueous solution of LIGNOSITE (sodium lignosulfonate (SL) from LIGNOTECH) is prepared and alkalized with caustic soda to pH 11.0-12.0 and oxidized with 5% hydrogen peroxide (250 vol) for one hour at 90° C. and with stirring to pH less than 10.5. It is spray dried and (OSL) is achieved.

An alternative way is to oxidize the sodium lignosulfonate solution with bubbling air. Into a 2 liter autoclave, 1000 ml of a 40% w/w aqueous sodium lignosulfonate solution are poured. The solution is alkalized with caustic soda to pH 11.0-12.0 and oxidized by bubbling air for 3 hours while keeping the temperature at 90° C. and with continued stirring until a final pH=10 is reached. It is spray dried.

Sample 10

1.9 g oxidized sulfoalkylated tannin are mixed with 1 g oxidized lignite and 0.32 g ferrous sulphate monohydrate.

Sample 16

1.9 g oxidized sulfoalkylated tannin are mixed with 1 g oxidized lignite and 0.32 g chrome acetate.

Sample 22

1.9 g oxidized sulfoalkylated tannin are mixed with 1 g oxidized lignite and 0.32 g Sodium stannate

Sample 12

1.9 g oxidized sulfoalkylated tannin are mixed with 1 g oxidized lignosulfonate and 0.32 g ferrous sulphate monohydrate.

Sample 18

1.9 g oxidized sulfoalkylated tannin are mixed with 1 g oxidized lignosulfonate and 0.32 g chrome acetate.

Sample 24

1.9 g oxidized sulfoalkylated tannin are mixed with 1 g oxidized lignosulfonate and 0.32 g Sodium stannate.

### EXAMPLE 1

This example compares the effectiveness of oxidized sulfomethylated quebracho tannin (OSMQ), oxidized lignite (OL), oxidized sodium lignosulfonate (OSL) and mixtures thereof.

Six (6) samples are prepared by adding 4.27 g/l of each additive to the aged mud, stirring for 20 minutes and adjusting to pH=10 with 30% w/w caustic soda. The samples are tested according to API RP-138 procedures of the American Petroleum Institute, both before and after the static aging at 300° F. for 16 hours.

TABLE A

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 4.27 g/l | PV | YP | GELS | WL | PV | YP | GELS | WL |
| SAMPLE 1 | 13 | 28 | 23/31 | — | 12 | 26 | 18/41 | 15 |
| SAMPLE 2 | 11 | 27 | 20/30 | — | 12 | 24 | 16/38 | 15.5 |
| SAMPLE 3 | 9 | 14 | 12/22 | — | 12 | 20 | 14/36 | 15 |
| SAMPLE 4 | 9 | 9 | 11/18 | — | 12 | 16 | 13/30 | 14 |
| SAMPLE 5 | 11 | 28 | 24/35 | — | 12 | 25 | 21/35 | 15 |
| SAMPLE 6 | 11 | 25 | 22/30 | — | 11 | 20 | 19/30 | 15 |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 1 | (SMQ) Sulfomethylated quebracho |
| 2 | (OSMQ) Oxidized sulfomethylated quebracho |
| 3 | 1.9 parts (SMQ) + 1 part (LIG) Causticized lignite |
| 4 | 1.90 parts (OSMQ) + 1 part Oxidized causticized lignite |
| | (OL) |
| 5 | 1.9 parts (SMQ) + 1 part sodium lignosulfonate (LS) |
| 6 | 1.9 parts (OSMQ) + 1 part Oxidized sodium lignosulfonate |
| | (OLS) |

The data from Table A show the greater effectiveness of the oxidized compounds compared to the non-oxidized ones.

The synergistic effect of replacing a part of the oxidized sulfomethylated quebracho by oxidized lignite (sample 4) or oxidized lignosulfonate (sample 6) can also be seen. In both instances, the yield point and gels are lower. this shows the convenience of the invention, since quebracho tannin is a raw material produced in scanty amounts and the preparation of sulfomethylated quebracho is a work consuming synthetic process. Lignite is abundantly found and it is also inexpensive, as is the case with lignosulfonates, which are a cellulose industry byproduct and its utilization is highly desirable.

### EXAMPLE II

This example shows the effectiveness of mixtures of two (2) and three (3) components wherein the metal component is selected from the group consisting of iron, ferrous sulphate monohydrate.

8.55 g/l additive were added to the base fluid and tainted with 5.7 g/l gypsum and 5.7 g/l sodium chloride. TABLE B. The samples where aged at 300° F. for 16 hours in a roller oven.

After cooling to room temperature, the mixture was stirred for 20 minutes and readjusted to pH=10.

TABLE B

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 8.55 g/l | PV | YP | GELS | WL | PV | YP | GELS | WL |
| SAMPLE 7 | 9 | 23 | 24/32 | — | 8 | 15 | 14/23 | |
| SAMPLE 8 | 8 | 21 | 20/28 | | 8 | 14 | 13/23 | |
| SAMPLE 9 | 7 | 23 | 19/26 | | 9 | 16 | 15/25 | |
| SAMPLE 10 | 9 | 21 | 19/25 | | 10 | 15 | 14/27 | |
| SAMPLE 11 | 8 | 23 | 23/28 | | 16 | 16 | 17/27 | |
| SAMPLE 12 | 8 | 21 | 21/26 | | 14 | 14 | 16/26 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 7 | (SMQ) 9 parts + ferrous sulphate monohydrate, 1 part |
| 8 | (OSMQ) 9 parts + ferrous sulphate monohydrate, 1 part |
| 9 | (SMQ) 1.9 parts + 0.32 part (LIG) + 0.32 parts ferrous |
| | sulphate monohydrate |
| 10 | (OSMQ) 1.9 parts + 1 (OL) + 0.32 parts ferrous sulphate |
| | monohydrate |
| 11 | (SMQ) 1.9 parts + (LS) 1 part + 0.32 parts ferrous sulphate |
| | monohydrate |
| 12 | (OSMQ) 1.9 parts + (OLS) oxidized sodium |
| | lignosulfonate + 0.32 parts ferrous sulphate monohydrate |

The data from Table B shows the greater effectiveness of the mixtures of oxidized components. In these cases, the oxidized lignite or oxidized sodium lignosulfonate replaces a part of the (OSMQ), while maintaining or increasing the efficacy.

Once again, from the data showing the mud rheologies it can be seen that the oxidized compounds, combined with iron salts, are more effective than the non-oxidized combinations. The replacement of a part of the oxidized sulfomethylated quebracho by oxidized lignite or oxidized lignosulfonate preserves and improves the rheological properties of the fluid.

It can thus be stated that the differences between oxidized and non-oxidized components are lesser due to a strong combined contamination with gypsum and sodium chloride.

It is desirable to replace a part of the oxidized sulfomethylated quebracho by oxidized lignite or lignosulfonate because they are more abundant and inexpensive materials.

### EXAMPLE III

This example shows the effectiveness of mixtures of two (2) and three (3) components wherein the metal component is selected from the group of chrome acetate.

8.55 g/l additive were added to the base fluid and contaminated with 5.7 g/l gypsum and 5.7 g/l sodium chloride. TABLE C. The samples where aged at 300° F. for 16 hours in a roller oven.

After cooling to room temperature, the mixture was stirred for 20 minutes and readjusted to pH=10.

TABLE C

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 8.55 g/l | PV | YP | GELS | WL | PV | YP | GELS | WL |
| SAMPLE 13 | 9 | 26 | 22/25 | | 9 | 11 | 11/20 | |
| SAMPLE 14 | 9 | 23 | 21/24 | | 9 | 10 | 11/20 | |
| SAMPLE 15 | 9 | 26 | 22/25 | | 9 | 18 | 15/22 | |
| SAMPLE 16 | 9 | 25 | 21/24 | | 10 | 18 | 15/23 | |
| SAMPLE 17 | 9 | 22 | 19/24 | | 9 | 12 | 13/18 | |
| SAMPLE 18 | 9 | 18 | 16/24 | | 8 | 10 | 12/18 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 13 | (SMQ) 9 parts + Chrome acetate 1 part |
| 14 | (OSMQ) 9 parts + Chrome acetate 1 part |
| 15 | (SMQ) 1.9 parts + (LIG) 1 part + Chrome Acetate 0.32 part |
| 16 | (OSMQ) 1.9 parts + 1 part (OL) + Chrome acetate 0.32 |
| | parts |
| 17 | (SMQ) 1.9 parts + (LS) Sodium lignosulfonate 1 part + |
| | Chrome Acetate 0.32 parts |
| 18 | (OSMQ) 1.9 parts + (OLS) oxidized sodium |
| | lignosulfonate + Chrome Acetate 0.32 parts |

The data from Table C shows the greater effectiveness of the mixtures of oxidized components. In these cases, the oxidized lignite or oxidized sodium lignosulfonate replace a part of the (OSMQ), while maintaining or increasing the efficacy. By replacing a part of the oxidized sulfomethylated quebracho by a part of oxidized sodium lignosulfonate (sample 18), a rheological control equivalent to that of the oxidized sulfomethylated quebracho (sample 14) is achieved. The differences between oxidized and non-oxidized components as to their yield point and gels are greater at low temperature and grow smaller as temperature rises.

### EXAMPLE IV

This example shows the effectiveness of mixtures of two (2) and three (3) components wherein the metal component is selected from the group of sodium stannate.

To the base fluid, 8.55 g/l additive were added and it was contaminated with 5.7 g/l gypsum and 5.7 g/l sodium chloride. TABLE D. The samples where aged at 300° F. for 16 hours in a roller oven. After cooling to room temperature, the mixture was stirred for 20 minutes and readjusted to pH=10.

TABLE D

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 8.55 g/l | PV | YP | GELS | WL | PV | YP | GELS | WL |
| SAMPLE 7 | 9 | 23 | 24/32 | — | 8 | 15 | 14/23 | |
| SAMPLE 19 | 9 | 19 | 19/31 | | 9 | 10 | 12/19 | |
| SAMPLE 20 | 9 | 17 | 17/32 | | 8 | 8 | 11/28 | |
| SAMPLE 21 | 9 | 23 | 21/28 | | 8 | 13 | 12/20 | |
| SAMPLE 22 | 9 | 20 | 19/31 | | 8 | 12 | 12/21 | |
| SAMPLE 23 | 9 | 18 | 19/30 | | 8 | 9 | 12/19 | |
| SAMPLE 24 | 9 | 14 | 18/32 | | 8 | 8 | 11/20 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 19 | (SMQ) 9 parts + Sodium stannate 1 part |
| 20 | (OSMQ) 9 parts + Sodium stannate 1 part |
| 21 | (SMQ)1.9 parts + (LIG) 1 part + Sodium stannate 0.32 |
| | parts |
| 22 | (OSMQ) 1.9 parts + 1 part (OL) + Sodium stannate 0.32 |
| | parts |
| 23 | (SMQ) 1.9 parts + (LS) Sodium lignosulfonate 1 part + |
| | Sodium stannate 0.32 parts |
| 24 | (OSMQ) 1.9 parts + (OLS) oxidized sodium |
| | lignosulfonate + Sodium stannate 0.32 parts |

The data from Table D shows the greater effectiveness of the mixtures of oxidized components. In these cases, the oxidized lignite or oxidized sodium lignosulfonate replace a part of the (OSMQ), while maintaining or increasing the efficacy. In this case, tin salts provide compounds that decrease viscosity in a stronger manner and the difference between oxidized and non-oxidized in the low temperature range is more marked. Again, a synergism is demonstrated, since a part of the oxidized sulfomethylated quebracho can be replaced for a part of oxidized sodium lignosulfonate without incurring in a loss of efficiency in terms of lowering the yield point and gels, as shown by samples 24 and 20.

### EXAMPLE V

This example shows the effectiveness of mixtures of oxidized quebracho, oxidized sodium lignosulfonate, iron, chrome and tin metal compounds compared to the commercial additive DESCO from Drilling specialties Co., USA.

To the base fluid, 2.85 g/l additive were added. (Table E). The samples were aged at 300° F. for 16 hrs. in a roller oven.

They were then cooled down to room temperature, stirred for 20 minutes and pH was adjusted to pH=10.

TABLE E

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 2.85 g/l | PV | YP | GELS | WL | PV | YP | GELS | WL |
| SAMPLE 25 | 9 | 1 | 0/0 | | 13 | 27 | 15/30 | |
| SAMPLE 26 | 8 | 1 | 0/0 | | 8 | 8 | 5/13 | |
| SAMPLE 27 | 7 | 0 | 0/0 | | 7 | 0 | 0/0 | |
| SAMPLE 28 | 8 | 16 | 12/15 | | 15 | 32 | 22/28 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 25 | (OSMQ) 1.9 parts + LSO 1 part + ferrous sulphate |
| | monohydrate 0.32 parts |
| 26 | (OSMQ) 1.9 parts + LSO 1 part + chrome acetate 0.32 |
| | parts |
| 27 | (OSMQ) 1.9 parts + (LSO) oxidized sodium lignosulfonate |
| | 1 part + chrome acetate 0.32 parts |
| 28 | DESCO |

This example shows the effectiveness of mixtures of oxidized quebracho, oxidized sodium lignosulfonate and iron, chrome and tin metal compounds, compared to the commercial additive DESCO from Drilling Specialties Co., USA.

### EXAMPLE VI

This example shows the effectiveness of dispersants in mud that has been contaminated with lime and compared to a commercial dispersant, DESCO from Drilling Specialties Co., USA.

To the fluid base, 2.85 g/l additive are added and contaminated with 5.7 g/l 10 lime. Table F. The samples were aged at 300° F. for 16 hrs. in a roller oven.

They were then cooled down to room temperature, stirred for 20 minutes and pH was adjusted to pH=10.

TABLE F

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 2.85 g/l | PV | YP | GELS | WL | PV | YP | GELS | WL |
| SAMPLE 29 | 7 | 22 | 19/24 | | 9 | 16 | 12/22 | |
| SAMPLE 30 | 7 | 21 | 17/22 | | 7 | 11 | 10/19 | |
| SAMPLE 31 | 10 | 14 | 14/20 | | 8 | 9 | 10/19 | |
| SAMPLE 32 | 6 | 28 | 15/23 | | 7 | 26 | 15/25 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 29 | (OSMQ) 1.9 parts + LSO 1 part + ferrous sulphate |
| | monohydrate 0.32 parts |
| 30 | (OSMQ) 1.9 parts + (LSO) 1 part + chrome acetate 0.32 |
| | parts |
| 31 | (OSMQ) 1.9 parts + (LSO) 1 part + sodium stannate 0.32 |
| | parts |
| 32 | DESCO |

Table F shows that dispersants are satisfactorily comparable to a commercial product.

### EXAMPLE VII

This example shows the effectiveness of mixtures of two (2) and three (3) components wherein the metal component is ferrous sulphate monohydrate.

To the base fluid, 2.85 g/l additive were added, and it is then rolled for 16 hours at 300° F. After cooling down to room temperature, it was stirred for 20 minutes and pH was adjusted to 10. Rheology is measured according to API standards RP-13B. SEE TABLE G.

TABLE G

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 2.85 g/l | PV | YP | GELS | WL | PV | YP | GELS | WL |
| SAMPLE 33 | 8 | 5 | 0/14 | | 11 | 25 | 21/34 | |
| SAMPLE 34 | 10 | 5 | 0/13 | | 13 | 20 | 10/19 | |
| SAMPLE 35 | 9 | 2 | 0/8 | | 11 | 20 | 18/34 | |
| SAMPLE 36 | 9 | 2 | 0/7 | | 13 | 18 | 16/32 | |
| SAMPLE 37 | 8 | 5 | 0/14 | | 12 | 29 | 28/46 | |
| SAMPLE 38 | 10 | 2 | 0/13 | | 13 | 23 | 25/44 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 33 | (SMQ) 0.9 parts + ferrous sulphate monohydrate 0.1 parts |
| 34 | (OSMQ) 0.9 parts + ferrous sulphate monohydrate 0.1 parts |
| 35 | (SMQ) 1.9 parts + Lignite 1 part (LI) + ferrous sulphate |
| | monohydrate 0.32 parts |
| 36 | (OSMQ) 1.9 parts + (OL) 1 part + ferrous sulphate |
| | monohydrate 0.32 parts |
| 37 | (SMQ) 1.9 parts + (LS) 1 part + ferrous sulphate |
| | monohydrate 0.32 parts |
| 38 | (OSMQ) 1.9 parts + (OLS) 1 part + ferrous sulphate |
| | monohydrate 0.1 parts |

The data on Table G shows that oxidized compounds are more effective in general, with the combination of oxidized sulfomethylated quebracho plus oxidized lignite being most efficient (sample 36) having a yield point of 18. The yield point or gels of sulfomethylated quebracho (sample 33) are higher, which indicates that both oxidation and replacement of a part of the oxidized sulfomethylated quebracho by oxidized lignite do not reduce effectiveness, but instead they increase it due to their synergistic effect (sample 36). Sample 35, which does not comprise any oxidized lignite, shows higher viscosity values.

### EXAMPLE VIII

This example shows the behavior of mixtures with chrome acetate in a non-contaminated mud.

To the base fluid, 2.85 g/l additive were added. TABLE H. The samples were aged for 16 hours at 300° F. in a roller oven. They were then cooled down to room temperature, stirred for 20 minutes and pH was adjusted to 10.

TABLE H

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 2.85 g/l | PV | YP | GELS | WL | PV | YP | GELS | WL |
| SAMPLE 39 | 10 | 27 | 24/32 | | 14 | 16 | 12/27 | |
| SAMPLE 40 | 10 | 25 | 23/31 | | 15 | 15 | 12/26 | |
| SAMPLE 41 | 10 | 16 | 17/27 | | 13 | 16 | 13/27 | |
| SAMPLE 42 | 10 | 10 | 14/19 | | 15 | 14 | 12/26 | |
| SAMPLE 43 | 10 | 26 | 23/30 | | 13 | 21 | 18/31 | |
| SAMPLE 44 | 10 | 21 | 20/27 | | 14 | 20 | 17/30 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 39 | (SMQ) 0.9 parts + chrome acetate 0.1 parts |
| 40 | (OSMQ) 0.9 parts + Chrome acetate 0.1 parts |
| 41 | (SMQ) 1.9 parts + (LI) 1 part + Chrome acetate 0.32 parts |
| 42 | (OSMQ) 1.9 parts + (OL) 1 part + Chrome acetate 0.32 |
| | parts |
| 43 | (SMQ) 1.9 parts + (LS) 1 part + Chrome acetate 0.32 parts |
| 44 | (OSMQ) 1.9 parts + (OLS) 1 part + Chrome acetate 0.1 |
| | parts |

The data on Table H shows that oxidized compounds with chrome salts and those containing oxidized lignite lower yield point more effectively. Furthermore, the replacement of part of (OSMQ) by oxidized lignite or oxidized lignosulfonate improves the dispersant additive.

### EXAMPLE IX

This example shows the behavior of the mixtures at low temperatures.

To the base fluid, 2.85 g/l additive were added. TABLE I. The samples were aged for 16 hours at 150° F. in a roller oven. They were then cooled down to room temperature, stirred for 20 minutes and pH was adjusted to 10.

TABLE I

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 2.85 g/l | PV | YP | GELS | WL | PV | YP | GELS | WL |
| SAMPLE 45 | 10 | 27 | 24/32 | | 11 | 10 | 9/22 | |
| SAMPLE 46 | 10 | 25 | 23/31 | | 11 | 9 | 8/21 | |
| SAMPLE 47 | 10 | 17 | 18/27 | | 10 | 10 | 8/21 | |
| SAMPLE 48 | 10 | 10 | 14/19 | | 11 | 8 | 7/19 | |
| SAMPLE 49 | 10 | 27 | 25/31 | | 11 | 12 | 10/23 | |
| SAMPLE 50 | 10 | 22 | 21/27 | | 11 | 9 | 8/21 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 45 | (SMQ) 0.9 parts + chrome acetate 0.1 parts |
| 46 | (OSMQ) 0.9 parts + Chrome acetate 0.1 parts |
| 47 | (SMQ) 1.9 parts + (LI) 1 part + Chrome acetate 0.32 parts |
| 48 | (OSMQ) 1.9 parts + (OL) 1 part + Chrome acetate 0.32 |
| | parts |
| 49 | (SMQ) 1.9 parts + (LS) 1 part + Chrome acetate 0.32 parts |
| 50 | (OSMQ) 1.9 parts + (OLS) 1 part + Chrome acetate 0.1 |
| | parts |

Table I indicates that at low temperatures, the differences with oxidized compounds are bigger. It also confirms again the synergism provided when replacing a part of the oxidized sulfomethylated quebracho. Samples 48 and 50 show that there is an improvement when oxidized lignite or oxidized lignosulfonate is introduced compared to oxidized sulfomethylated tannin.

### EXAMPLE X

This example shows the dispersant properties of oxidized compounds with iron salts in non-contaminated muds. To the base fluid, 2.85 g/l additive were added and aged for 16 hours at 300° F. in a roller oven. It is then cooled down, stirred for 20 minutes and pH is adjusted to pH=10.

TABLE J

| | | | | | Properties after | | | |
|---|---|---|---|---|---|---|---|---|
| | | | | | static aging for | | | |
| BASE FLUID | Starting properties | | | | 16 hrs. at 300° F. | | | |
| ADDITIVE 2.85 g/l | PV | YP | GELS | WL | PV | YP | GELS | WL |
| SAMPLE 51 | 8 | 5 | 0/13 | | 11 | 25 | 21/34 | |
| SAMPLE 52 | 10 | 5 | 0/15 | | 13 | 23 | 20/33 | |
| SAMPLE 53 | 9 | 2 | 0/8 | | 11 | 20 | 18/34 | |
| SAMPLE 54 | 9 | 2 | 0/7 | | 13 | 18 | 16/32 | |
| SAMPLE 55 | 8 | 5 | 0/14 | | 12 | 29 | 28/46 | |
| SAMPLE 56 | 10 | 2 | 0/13 | | 13 | 26 | 25/44 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 51 | (SMQ) 0.9 parts + Ferrous sulphate monohydrate 0.1 parts |
| 52 | (OSMQ) 0.9 parts + Ferrous sulphate monohydrate 0.1 |
| | parts |
| 53 | (SMQ) 1.9 parts + (LI) 1 part + Ferrous sulphate |
| | monohydrate 0.32 parts |
| 54 | (OSMQ) 1.9 parts + (OL) 1 part + Ferrous sulphate |
| | monohydrate 0.32 parts |
| 55 | (SMQ) 1.9 parts + (LS) 1 part + Ferrous sulphate |
| | monohydrate 0.32 parts |
| 56 | (OSMQ) 1.9 parts + (OLS) 1 part + Ferrous sulphate |
| | monohydrate 0.1 parts |

Table J shows that oxidized compounds with iron salts lower the yield point more effectively, particularly with combinations of oxidized sulfomethylated quebracho and oxidized lignite.

### EXAMPLE XI

This example serves to illustrate the advantages of oxidized compounds static aged for 64 hours, thus simulating a lack of circulation of the well drilling fluid for the given amount of hours.

To the base fluid, 2.85 g/l additive were added (TABLE K) and static aged for 64 hours at 130° F. After its cooled down to room temperature, it is stirred for 20 minutes and pH is adjusted to pH=10.

TABLE K

| | | | | | Properties after | | | |
|---|---|---|---|---|---|---|---|---|
| | | | | | static aging | | | |
| BASE FLUID | Starting properties | | | | for 16 hrs. at 300° F. | | | |
| ADDITIVE 2.85 g/l | PV | YP | GELS | WL | PV | YP | GELS | WL |
| SAMPLE 57 | 9 | 0 | 0/0 | 14 | 11 | 22 | 17/37 | 13 |
| SAMPLE 58 | 9 | 0 | 0/0 | 8 | 12 | 19 | 15/37 | 10 |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 57 | (SMQ) 1.9 parts + (LI) Lignite 1 part + Sodium stannate |
| | 0.32 parts |
| 58 | (OSMQ) 1.9 parts + (OL) Oxidized lignite 1 part + Sodium |
| | stannate 0.32 parts |

The data from TABLE K show that the oxidized compound has a lower yield point and lower water loss.

### EXAMPLE XII

This illustrates the advantages of oxidized compounds static aged for 16 hours at 300° F., when contaminated with cement.

To the fluid base, 4.27 g/l additive contaminated with 5.7 g/l cement was added and it was left to static age for 16 hours at 300° F. Upon cooling down to room temperature, it is stirred for 20 minutes and pH is adjusted to pH=10.

TABLE L

| | | | | | Properties after | | | |
|---|---|---|---|---|---|---|---|---|
| | | | | | static aging | | | |
| BASE FLUID | Starting properties | | | | for 16 hrs. at 300° F. | | | |
| ADDITIVE 2.85 g/l | PV | YP | GELS | WL | PV | YP | GELS | WL |
| SAMPLE 59 | 7 | 11 | 14/23 | | 6 | 17 | 17/27 | |
| SAMPLE 60 | 8 | 9 | 14/26 | | 8 | 16 | 18/32 | |
| SAMPLE 61 | 7 | 14 | 14/27 | | 7 | 16 | 15/29 | |
| SAMPLE 62 | 7 | 9 | 13/26 | | 7 | 14 | 14/30 | |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 59 | (SMQ) 1.9 parts + (LI) Lignite 1 part + Ferrous sulphate |
| | monohydrate 0.32 parts |
| 60 | (OSMQ) 1.9 parts + (OL) oxidized lignite 1 part + Ferrous |
| | sulphate monohydrate 0.32 parts |
| 61 | (SMQ) 1.9 parts + (LS) lignosulfonate 1 part + Ferrous |
| | sulphate monohydrate 0.32 parts |
| 62 | (OSMQ) 1.9 parts + (OLS) Oxidized sodium lignosulfonate |
| | 1 part + Ferrous sulphate monohydrate 0.32 parts |

The data from Table L show the improved behavior of oxidized compounds, particularly those containing oxidized sodium lignosulfonate (OLS), which replaces a part of the oxidized sulfomethylated quebracho.

### EXAMPLE XIII

In this example, various iron, chrome and tin salts, in combination with oxidized sulfomethylated Quebracho and Oxidized Sodium Lignosulfonate are compared.

To the base fluid contaminated with 5.7 g/l gypsum and 5.7 g/l sodium chloride, 8.55 g/l additive is added. It is aged for 16 hours at 300° F. in a roller oven. It is cooled to room temperature, stirred for 20 minutes and pH is readjusted to pH=10.

TABLE M

| | | | | Rolled for 16 hrs. | | |
|---|---|---|---|---|---|---|
| | Cold | | | at 300° F. | | |
| | PV | YP | GELS | PV | YP | GELS |
| SAMPLE 63 | 8 | 24 | 20/26 | 8 | 18 | 17/22 |
| SAMPLE 64 | 8 | 20 | 18/24 | 7 | 16 | 14/20 |
| SAMPLE 65 | 9 | 20 | 17/27 | 8 | 16 | 15/22 |
| SAMPLE 66 | 9 | 15 | 15/25 | 8 | 14 | 13/20 |
| SAMPLE 67 | 9 | 14 | 17/31 | 8 | 12 | 13/21 |
| SAMPLE 68 | 9 | 12 | 16/28 | 9 | 11 | 12/20 |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 63 | (SMQ) 1.9 parts + (LS) 1 part Ferrous sulphate |
| | monohydrate 0.32 parts |
| 64 | (OSMQ) 1.9 parts + (OLS) 1 part + Ferrous sulphate |
| | monohydrate 0.32 parts |
| 65 | (SMQ) 1.9 parts + (LS) 1 part + Chrome acetate 0.32 parts |
| 66 | (OSMQ) 1.9 parts + (OLS) 1 part + Chrome acetate 0.32 |
| | parts |
| 67 | (SMQ) 1.9 parts + (LS) 1 part + Sodium stannate 0.32 parts |
| 68 | (OSMQ) 1.9 parts + (OLS) 1 part + Sodium stannate 0.32 |
| | parts |

The data from Table M shows that the replacement of a part of the oxidized sulfomethylated quebracho (OSMQ) by oxidized sodium lignosulfonate (OLS) improves the additive and that oxidized compositions are more effective with any combination of salts (iron, chrome, tin).

### EXAMPLE XIV

In this example, the combination of sulfomethylated quebracho and Lignite to iron salts (both oxidized and non-oxidized), contaminated with gypsum and static aged.

To the base fluid, contaminated with 5.7 g/l gypsum, and static aged at 300° F. for 16 hours, 2.85 g/l additive is added. It is then cooled, stirred for 20 minutes and the pH is adjusted to pH=10 (TABLE M).

TABLE N

| | | | | | Properties after | | | |
|---|---|---|---|---|---|---|---|---|
| | | | | | static aging | | | |
| BASE FLUID | Starting properties | | | | for 16 hrs. at 300° F. | | | |
| ADDITIVE 2.85 g/l | PV | YP | GELS | WL | PV | YP | GELS | WL |
| SAMPLE 69 | 11 | 32 | 23/23 | | 8 | 27 | 20/22 | 13 |
| SAMPLE 70 | 10 | 26 | 20/21 | | 8 | 19 | 13/15 | 10 |

PV: Plastic viscosity in centipoise
YP: Yield point in lb/100 ft²
GELS: Gels strengths in lb/100 ft², 10 sec. and 10 min.
WL: Water loss in ml/30 minutes.

| Sample No. | Mixture ratios |
|---|---|
| 69 | (SMQ) 1.9 parts + (LI) 1 part + Ferrous sulphate |
| | monohydrate 0.32 parts |
| 70 | (OSMQ) 1.9 parts + (OL) 1 part + Ferrous sulphate |
| | monohydrate 0.32 parts |

Table N shows that oxidized compounds are more effective to lower both yield point and gels.

A drilling fluid comprising a mixture of this invention can contain other additives when needed to adjust its properties according to conventional use. It is understood that other additives may be present in the fluid of this invention without departing from the object herein.

While certain aspects of the invention have been specifically disclosed, it will be apparent that the invention is not limited thereto, since various modifications will be apparent to person normally skilled in the art upon reading the description herein. Such modifications are within the scope of the invention.

What is claimed is:

1. An additive composition to improve the properties of drilling, completion and work-over fluids comprising, in a blend:
I) sulfoalkylated tannin, modified by strong oxidation; and
III) a metal compound comprising at least one metal, wherein the metal is selected from the group consisting of iron, tin, chrome, manganese, titanium, aluminum and zinc.

2. The composition of claim 1 further comprising, in a blend:
a component (II), wherein component (II) is selected from the group consisting of oxidized causticized lignite, non-oxidized causticized lignite, oxidized lignosulfonate salt, non-oxidized lignosulfonate salt, and mixtures thereof.

3. The composition of claim 1 comprising from 40 to 90 wt % of component (I).

4. The composition of claim 2 comprising from 10 to 50 wt % of component (II).

5. The composition of claim 1 comprising from 5 to 25 wt % of component (III).

6. The composition of claim 1, wherein oxidized sulfoalkylated tannin is oxidized sulfoalkylated quebracho tannin.

7. The composition of claim 2 wherein component (II) is an oxidized causticized lignite.

8. The composition of claim 2 wherein component (II) is an oxidized lignosulfonate salt.

9. The composition of claim 1, wherein the metal compound is partially soluble.

10. The composition of claim 1, wherein the metal compound comprises at least one salt, wherein the salt is selected from the group consisting of Fe⁺⁺ salt, Cr⁺³ salt, Sn⁺⁴ salt, and mixtures thereof.

11. The composition of claim 1, wherein the metal compound comprises at least one salt, wherein the salt is selected from the group consisting of potassium stannate salt, sodium stannate salt, and mixtures thereof.

12. The composition of claim 1, wherein the metal compound comprises a chrome acetate salt.

13. The composition of claim 1, wherein the metal compound comprises an iron salt.

14. The composition of claim 1, wherein the metal compound comprises monohydrated ferrous sulphate.

15. A method of preparing an additive composition to improve the properties of drilling, completion and work-over fluids, wherein the composition comprises, in a blend: I) a sulfoalkylated tannin, modified by strong oxidation; and III) a metal compound comprising at least one metal, wherein the metal is selected from the group consisting of iron, tin, chrome, manganese, titanium, aluminum and zinc; the method comprises the steps of:
a) preparing an aqueous solution of a sulfoalkylated tannin, optionally with a causticized lignite, and/or a lignosulfonate salt;
b) strongly oxidizing said aqueous solution under basic conditions to a final pH less than 10,
c) drying said strongly oxidized aqueous solution to achieve a powder,
d) mixing the powder with a metal compound comprising at least one metal, wherein the metal is selected from the group consisting of iron, tin, chrome, manganese, titanium, aluminum and zinc.

16. The method of claim 15, wherein the composition further comprises, in a blend: a component (II), wherein component (II) is selected from the group consisting of oxidized causticized lignite, non-oxidized causticized lignite, oxidized lignosulfonate salt, non-oxidized lignosulfonate salt, and mixtures thereof, and wherein step (a) includes preparing an aqueous solution of a sulfoalkylated tannin, with component (II).

17. The method of claim 15, wherein the strong oxidation is effected with H₂O₂ (250 vol) in a ratio of at least 0.6% w/w.

18. The method of claim 15, wherein the oxidation time is from 1 to 6 hours.

19. The method of claim 15, wherein the oxidation temperature is from 70 to 110° C.

20. The method of claim 19, wherein the oxidation temperature is about 90° C.

21. The method of claim 16, wherein the aqueous solution prepared in step (a) comprises a sulfoalkylated quebracho tannin and a causticized lignite.

22. The method of claim 16, wherein the aqueous solution prepared in step (a) comprises a sulfoalkylated quebracho tannin and a lignosulfonate salt.

23. An aqueous suspension useful as a drilling, completion, or work-over fluid, comprising water, a sufficient amount of finely divided solids to form a cake on the walls of the well bore, and an effective amount of an additive composition, wherein the additive composition comprises, in a blend: I) sulfoalkylated tannin, modified by strong oxidation and III) a metal compound comprising at least one metal, wherein the metal is selected from the group consisting of iron, tin, chrome, manganese, titanium, aluminum and zinc.

24. The aqueous suspension of claim 23, wherein the additive composition further comprises, in a blend: a component (II), wherein component (II) is selected from the group consisting of oxidized causticized lignite, non-oxidized causticized lignite, oxidized lignosulfonate salt, non-oxidized lignosulfonate salt, and mixtures thereof.

25. The aqueous suspension of claim 23, wherein the additive composition is present in a sufficient amount to decrease at least one fluid parameter, wherein the fluid parameter is selected from the group consisting of: a) viscosity; b) yield point; c) gels; d) shear stress; and e) water-loss caused by filtering.

26. A method of drilling a well bore into the earth, wherein said method comprises circulating a drilling fluid containing an additive composition through a drilling bit and a drill string, wherein the additive composition comprises, in a blend: I) sulfoalkylated tannin, modified by strong oxidation and III) a metal compound comprising at least one metal, wherein the metal is selected from the group consisting of iron, tin, chrome, manganese, titanium, aluminum and zinc.

27. The method of claim 26, wherein the additive composition further comprises, in a blend: a component (II), wherein component (II) is selected from the group consisting of oxidized causticized lignite, non-oxidized causticized lignite, oxidized lignosulfonate salt, non-oxidized lignosulfonate salt, and mixtures thereof.
